(19) United States
(12) Patent Application Publication
(10) Pub. No.: US 2014/0340829 A1
(43) Pub. Date: Nov. 20, 2014

(54) ELECTRONIC DEVICE

(71) Applicant: Kabushiki Kaisha Toshiba, Tokyo (JP)

(72) Inventors: Takuo Matsumoto, Tokyo (JP); Ryosuke Saito, Tokyo (JP)

(73) Assignee: Kabushiki Kaisha Toshiba, Tokyo (JP)

(21) Appl. No.: 14/024,512

(22) Filed: Sep. 11, 2013

(30) Foreign Application Priority Data
May 17, 2013 (JP) 2013-104947

(51) Int. Cl. G06F 1/16

(52) U.S. Cl. CPC G06F 1/1637
USPC 361/679.27

(57) ABSTRACT

According to one embodiment, electronic device includes a display device, a first housing, a second housing, and a movable portion. The display device includes a display screen. The first housing includes a first end and a second end opposite the first end. The display device is positioned between the first end and the second end. The first housing supports the display device. The movable portion includes a first part and a second part. The first part is rotatably connected to the first housing around a first rotational axis and reciprocatably connected to the first housing in a direction intersecting the first rotational axis. The second part is rotatably connected to the second housing around a second rotational axis extending along the first rotational axis and detachably connected to the second housing. The movable portion is configured to change an angle of the first housing with respect to the second housing.

### CROSS-REFERENCE TO RELATED APPLICATIONS

This application is based upon and claims the benefit of priority from Japanese Patent Application No. 2013-104947, filed May 17, 2013, the entire contents of which are incorporated herein by reference.

### FIELD

An embodiment described herein relates generally to an electronic device.

### BACKGROUND

Conventionally, there have been known some electronic devices comprising a first housing to which a display device is provided and a second housing supporting the first housing, allowing the position (posture) of the first housing to be changed with respect to the second housing.

For this type of device, it is desired to for example improve usability.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary side view of an electronic device according to an embodiment;

FIG. 2 is an exemplary side view of one example of the electronic device in a folded state, in the embodiment;

FIG. 3 is an exemplary side view of one example of the electronic device in a state in which a first device and a second device are separated from each other, in the example;

FIG. 4 is an exemplary side view of one example of the electronic device in a state in which the first device that is engaged with a recessed portion is inclined with respect to the second device, in the embodiment;

FIG. 5 is an exemplary side view of one example of the electronic device in a state in which the first device that is engaged with the recessed portion is perpendicular with respect to the second device, in the embodiment;

FIG. 6 is an exemplary front view of the first device of one example of the electronic device in the embodiment;

FIG. 7 is an exemplary perspective view of the back side of the first device of one example of the electronic device in the embodiment;

FIG. 8 is an exemplary side view of the first device of one example of the electronic device in the embodiment;

FIG. 9 is an exemplary schematic diagram of an internal configuration of the first device of one example of the electronic device in the embodiment;

FIG. 10 is an exemplary side view of the first device of one example of the electronic device, and schematically illustrating a movable portion that slides and moves, in the embodiment; and

FIG. 11 is an exemplary plan view of the second device of one example of the electronic device in the embodiment.

### DETAILED DESCRIPTION

In general, according to one embodiment, an electronic device comprises a display device, a first housing, a second housing, and a movable portion. The display device comprises a display screen. The first housing comprises a first end and a second end opposite the first end. The display device is positioned between the first end and the second end. The first housing is configured to support the display device. The movable portion comprises a first part and a second part. The first part is rotatably connected to the first housing around a first rotational axis and reciprocatably connected to the first housing in a direction intersecting the first rotational axis. The second part is rotatably connected to the second housing around a second rotational axis extending along the first rotational axis and detachably connected to the second housing. The movable portion is configured to change an angle of the first housing with respect to the second housing.

With reference to the accompanying drawings, an exemplary embodiment will be described hereinafter. While the following embodiment illustrates and describes an electronic device being configured as a personal computer, the electronic device according to the embodiment is not limited thereto. The electronic device in the embodiment can be configured as various types of electronic devices, for example, a smartphone, a cellular phone, a personal digital assistant (PDA), an electronic dictionary, a video display device, and a videophone.

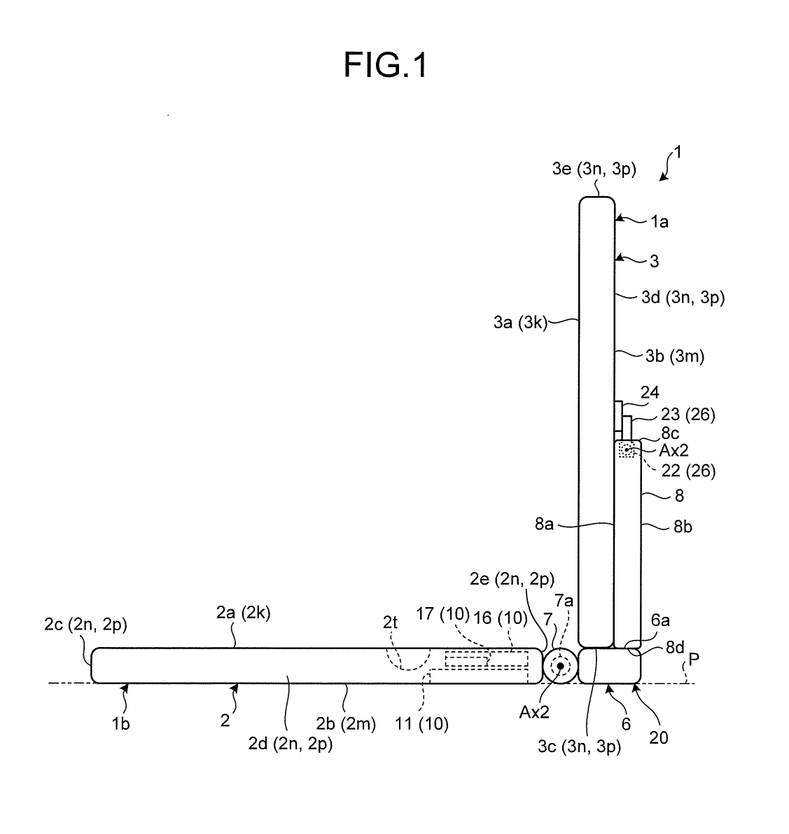

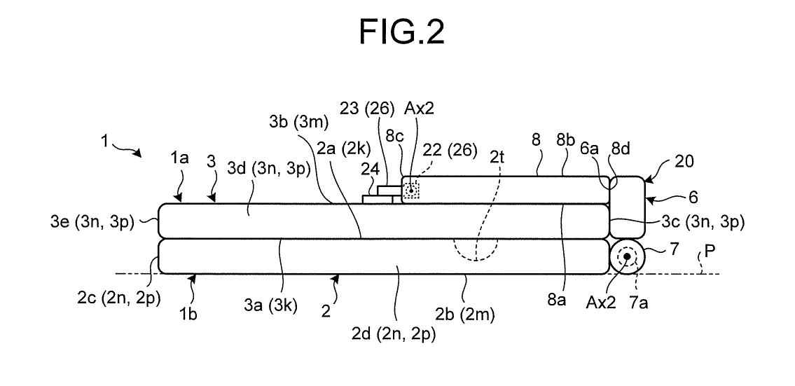

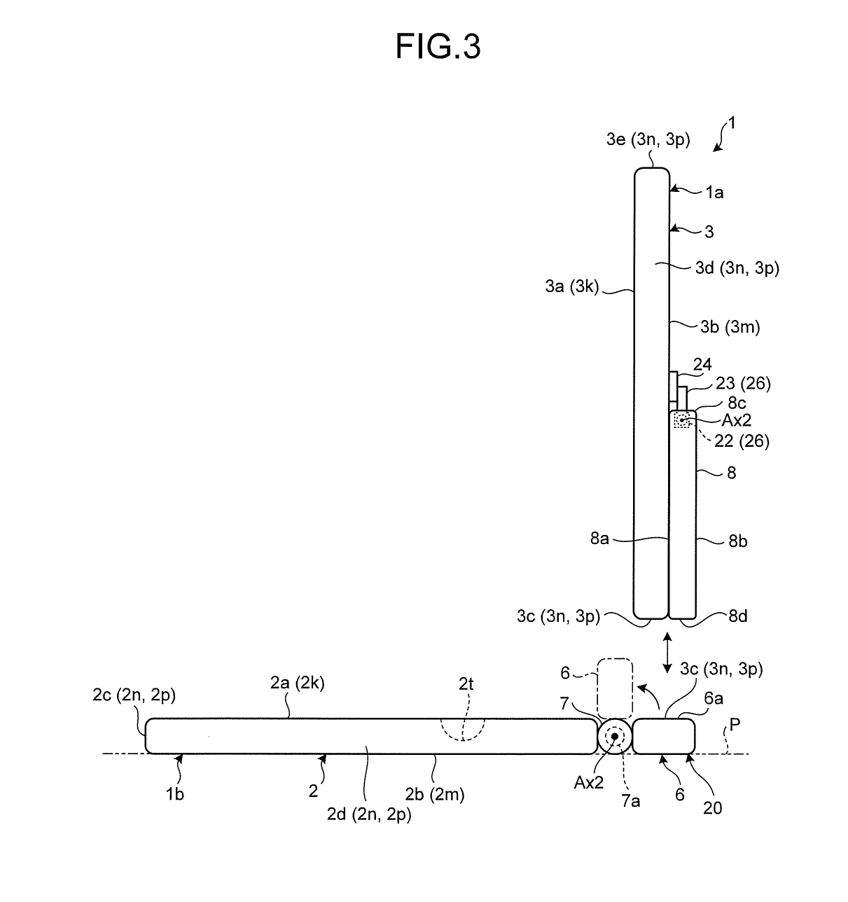

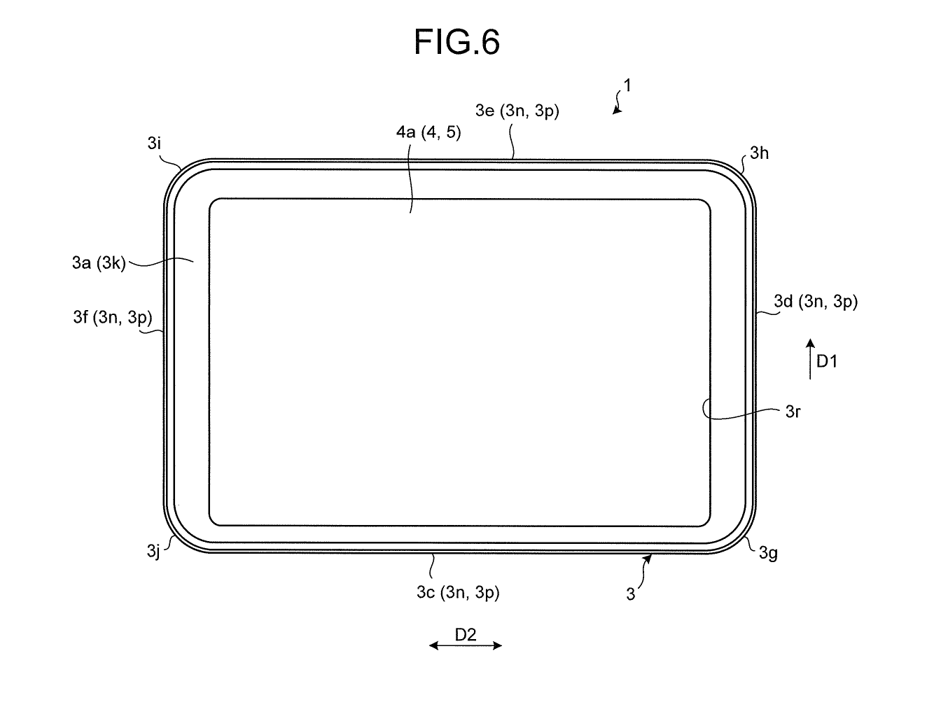

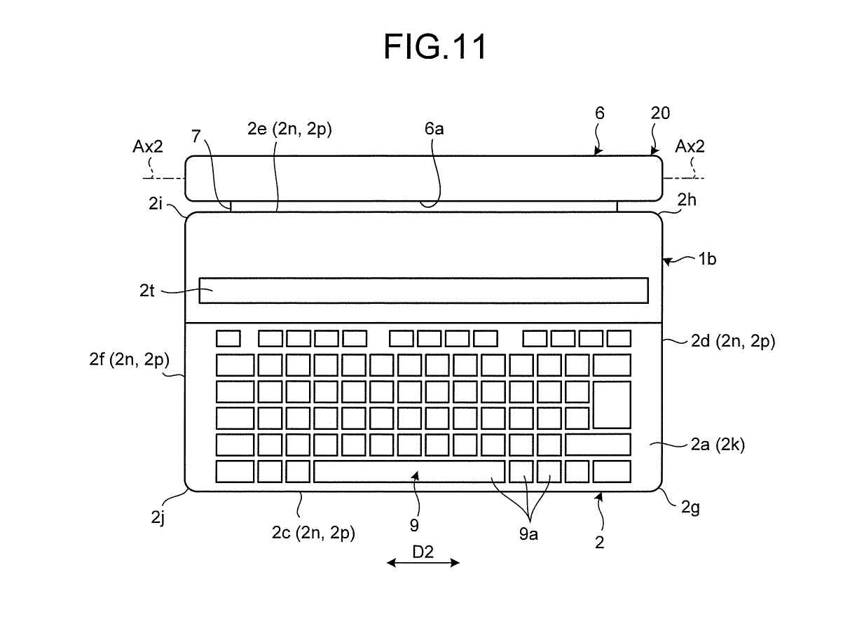

In the embodiment, as illustrated in FIGS. 1 and 2 as one example, an electronic device 1 comprises a device 1a (electronic device, first device, or part) comprising a housing 3 and a display device 4 (see FIG. 6), and a device 1b (second device, second part, or part) comprising a housing 2 and a keyboard module 9 (see FIG. 11). The device 1a is a tablet device as one example, and the device 1b is a function expanding device (keyboard device) as one example. The device 1a is connected to the device 1b by a connecting mechanism 20 as one example. Furthermore, as illustrated in FIG. 3, the device 1a (the housing 3) is detachable with respect to the device 1b (the housing 2). The device 1a can be used in clamshell mode in which the device 1a is connected to the device 1b (see FIGS. 1, 2, 4, and 5), and in tablet mode in which the device 1a is not connected to the device 1b (see FIG. 3). In the embodiment, as can be seen from FIGS. 1, 4, and 5 as one example, the position (posture) of the device 1a can be changed with respect to the device 1b in the clamshell mode.

In the embodiment, the housing 3 (first housing or first component) of the device 1a supports the display device 4 (display module, display, panel, or display component) as one example. The housing 3 houses therein at least a portion of the display device 4.

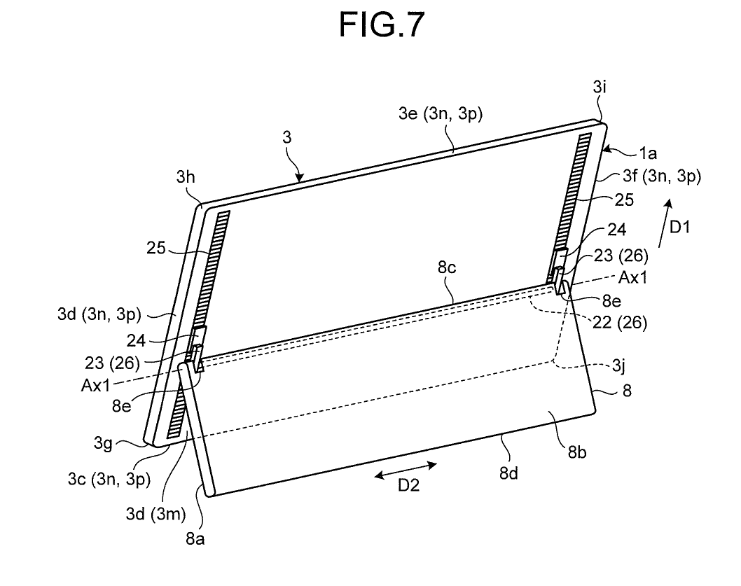

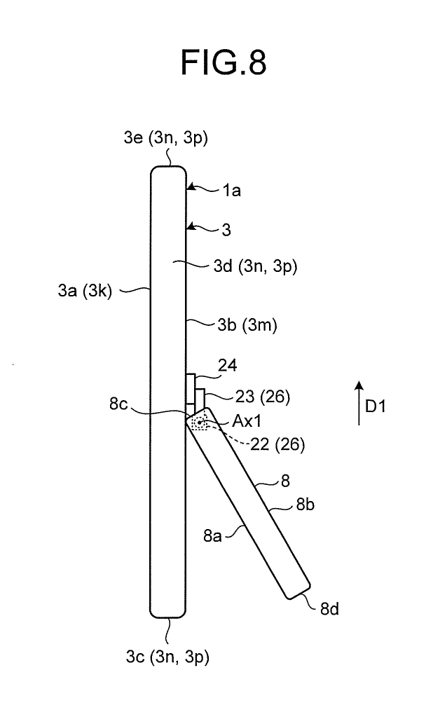

In the embodiment, as illustrated in FIGS. 6, 7, and the like for example, the housing 3 appears in a quadrangular shape (a rectangular shape as one example in the embodiment) in a frontal view and in a back view. The housing 3 is further constructed, as illustrated in FIG. 8 and the like for example, in a rectangular parallelepiped shape to be thin and flat in a front and back direction (thickness direction of the housing 3, or normal direction of a display screen 4a). The housing 3 comprises, as illustrated in FIGS. 6 to 8 and the like, a face 3a (front face, anterior face, surface, face portion), and a face 3b (back face, rear face, reverse face, or face portion) opposite the face 3a. The face 3a and the face 3b are provided in a posture facing opposite to each other (in parallel with each other as one example in the embodiment). The housing 3 comprises four ends 3c to 3f (sides or edges) and four corners 3g to 3j (protruding portions, rounded portions, or end portions) in a frontal view. The ends 3c and 3e are examples of the long sides. The ends 3d and 3f are examples of the short sides. In the embodiment, the display device 4 is positioned between the end 3c (first end) and the end 3e (second end) opposite the end 3c. The housing 3 further comprises four faces 3p (side faces, bridging faces, or face portions) extending between the face 3a and the face 3b. The faces 3p are not necessarily needed to be clearly defined from one another by a pointed corner or the like, and may be smoothly connected via a bend portion or the like.

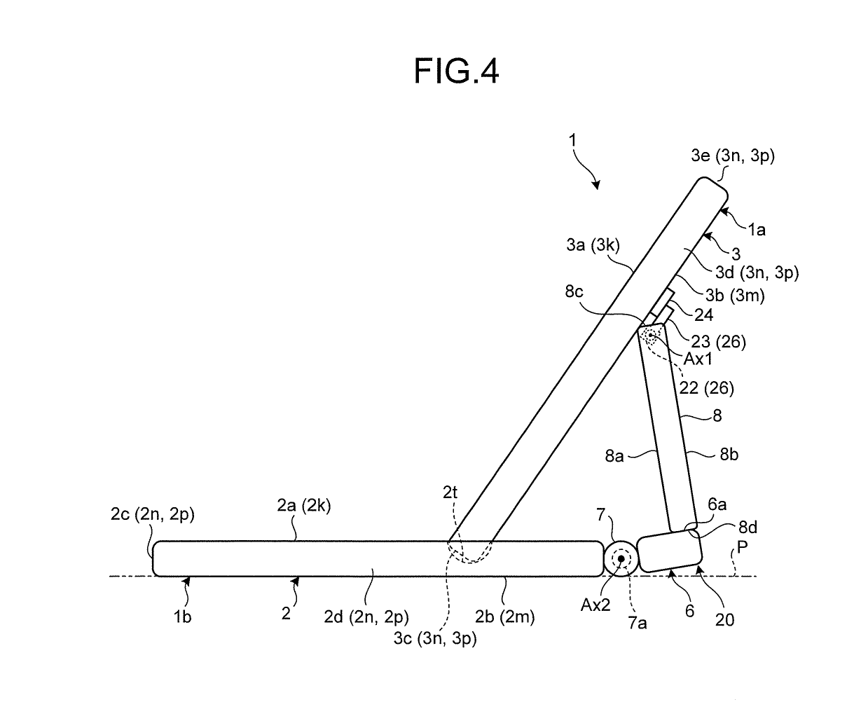

The housing 3 further comprises a wall 3k (part, plate, frame, front wall, surface wall, or top wall) positioned on the front side, and a wall 3m (portion, plate, back wall, rear wall, or bottom wall, see FIG. 4 and the like) positioned on the back side. The walls 3k and 3m are in a quadrangular shape (a rectangular shape as one example in the embodiment) as one example. On the wall 3k, an opening 3r in a quadrangular shape is provided, and from the opening 3r, the display device (the display screen 4a) is exposed. The wall 3k further surrounds the circumferential edge of the display device 4 (the display screen 4a). The wall 3m is in a quadrangular plate-like shape. The wall 3m covers the reverse face (not illustrated) of the display device 4 positioned opposite the display screen 4a. The housing 3 further comprises four walls 3n (parts, plates, side walls, end walls, standing walls, or bridging portions) extending between the wall 3k and the wall 3m. The walls 3n intersect with the walls 3k and 3m, lie along the side faces (not illustrated) of the display device 4, and cover the side faces. The walls 3k and 3m and the walls 3n are not necessarily needed to be clearly defined from one another by a pointed corner or the like, and may be smoothly connected via a bend portion or the like. The cross-section of the walls 3k and 3m and the walls 3n may be a series of arcs. The walls 3k and 3m are nearly in parallel with each other. The housing 3 can further comprise a wall (part, plate, frame, intermediate wall, inner wall, middle plate, middle frame, or third wall, not illustrated) positioned between the wall 3k and the wall 3m.

In the embodiment, the housing 3 can be configured with a plurality of members (housing members, components, or segmented bodies) combined as one example. The members constituting the housing 3 can be, for example, synthetic resin material (such as plastic and engineering plastic) and metallic material (such as aluminum alloy, magnesium alloy, and stainless steel).

In the embodiment, the display device 4 appears in a quadrangular shape (a rectangular shape as one example in the embodiment) in a frontal view. The display device 4 is configured in a rectangular parallelepiped shape to be thin and flat in the front and back direction (thickness direction of the housing 3). The display device 4 is, for example, a liquid crystal display (LCD) and an organic electro-luminescent display (OELD). The display device 4 comprises the display screen 4a. The display device 4 can be a flexible display. A user is able to view the display screen 4a from the front side (anterior side) through the opening 3r. The display screen 4a of the display device 4 is covered with a transparent portion of a touch panel 5 (touch sensor or input operation panel). The touch panel 5 can be configured as an in-cell touch panel incorporated in the display device 4.

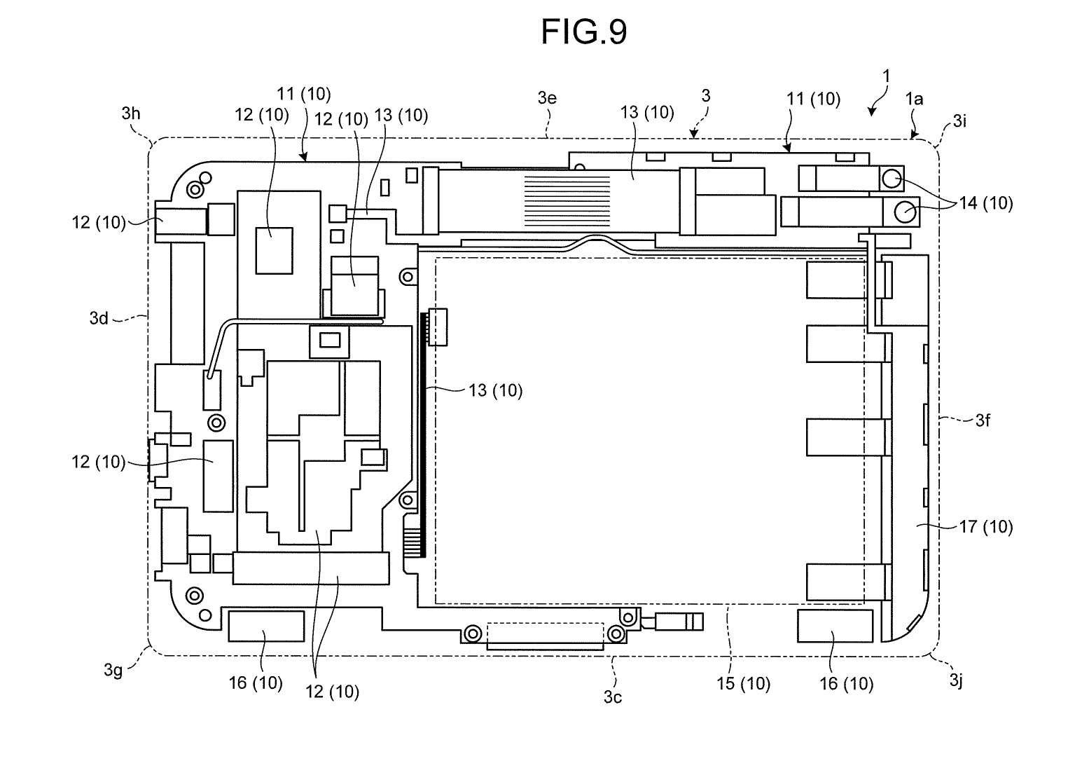

In the embodiment, as illustrated in FIG. 9 as one example, on the posterior side (rear side, back side, wall 3m side, or side opposite the display screen 4a) of the display device 4 in the housing 3, further housed (provided) as electrical components 10 (components or first electrical components) are a circuit board 11 (substrate, printed-circuit board, or control board), wiring 13 (such as cables, harnesses, flexible cables, and flexible printed wiring boards), a camera module 14 (camera unit, camera assembly, camera, or imaging device), a battery module 15 (battery, assembled battery, cell, module, battery pack, or battery unit), a speaker module 16 (speaker unit, speaker assembly, speaker, or audio output device), an antenna module 17 (antenna unit, antenna assembly, antenna, or first transmitting and receiving module), and the like. The electrical components 10 are electrically connected to the respective other electrical components 10 via the wiring 13. The antenna module 17 provided on the housing 3 is electrically connected to the circuit board 11 (first electrical components) provided on the housing 3, and transmits and receives data in a wireless manner. In the housing 3, although not depicted, a vibration generator (a motor attached with an eccentric weight as one example) and the like can be housed. On the circuit board 11, various components 12 (electronic components, elements, chips, packages, and others) are provided (mounted) as the electrical components 10.

In the embodiment, the battery module 15 can be configured as a lithium-ion secondary battery as one example. In the embodiment, the battery module 15 supplies the electric power required for the electronic device 1 to perform operations, such as displaying videos and outputting sound, to the electrical components 10 provided on the housing 3 in addition to the display device 4 via the wiring 13 and the like as one example. The battery module 15 can further supply the electric power to an external device electrically connected to the circuit board 11 and the like via the wiring 13, a conducting body portion (bus bar, not illustrated), a connector (not illustrated), and the like. In the embodiment, the battery module 15 appears in a quadrangular shape in a frontal view and in a back view, and is shaped thin and flat in the thickness direction of the housing 3 as one example.

In the embodiment, the circuit board 11 can be mounted with the components 12 provided in plurality, for example, a central processing unit (CPU), a graphics controller, power supply circuit components, a platform controller hub (PCH), a memory slot connector, an LCD connector, an input/output (I/O) connector, a power coil, elements, and a universal serial bus (USB) connector as one example.

Furthermore, in the embodiment, as illustrated in FIGS. 1, 11, and the like as one example, the housing 2 (second housing, stand, cradle, dock, docking station, supporting portion, or holding portion) of the device 1b appears in a quadrangular shape (a rectangular shape as one example in the embodiment) in a frontal view and in a back view. The housing 2 is configured in a rectangular parallelepiped shape to be thin and flat in an up and down direction (thickness direction of the housing 2). The housing 2 comprises a face 2a (front face, top face, surface, or face portion) and a face 2b (back face, bottom face, reverse face, or face portion, see FIG. 1) on the side opposite the face 2a. The face 2a and the face 2b are provided in a posture facing opposite to each other (in parallel with each other as one example in the embodiment). The housing 2 comprises four ends 2c to 2f (sides or edge s, see FIG. 11) and four corners 2g to 2j (protruding portions, rounded portions, or ends, see FIG. 11) in a frontal view. The ends 2c and 2e are examples of the long sides. The ends 2d and 2f are examples of the short sides. The housing 2 further comprises four faces 2p (side faces, bridging faces, or face portions) extending between the face 2a and the face 2b. The faces 2p are not necessary to be clearly defined by a pointed corner or the like, and may be smoothly connected via a bend portion or the like.

In the embodiment, the housing 2 further comprises a wall 2k (part, plate, frame, upper wall, surface wall, or top wall) positioned on the front side, and a wall 2m (part, plate, lower wall, rear wall, or bottom wall, see FIG. 1) positioned on the back side as one example. The electronic device 1 can be used, placed on a placement face P (plane, see FIG. 1), in a posture of the face 2b (the wall 2m) of the housing 2 being placed along the placement face P as one example. The walls 2k and 2m are in a quadrangular shape (a rectangular shape as one example in the embodiment). The housing 2 further comprises four walls 2n (parts, plates, side walls, end walls, standing walls, or bridging portions) extending between the wall 2k and the wall 2m. The walls 2n intersect with the walls 2k and 2m. The walls 2k and 2m and the walls 2n are not necessarily needed to be clearly separated, and may be smoothly connected via a bend portion or the like. The cross-section of the walls 2k and 2m and the walls 2n may be a series of arcs. The housing 2 can further comprise a wall (part, plate, frame, intermediate wall, inner wall, middle plate, middle frame, or third wall, not illustrated) positioned between the wall 2k and the wall 2m.

Furthermore, in the embodiment, the housing 2 can be constructed with a plurality of members (housing members, components, or segmented bodies) combined as one example. The members configuring the housing 2 can be, for example, synthetic resin material (such as plastic and engineering plastic) and metallic material (such as aluminum alloy, magnesium alloy, and stainless steel).

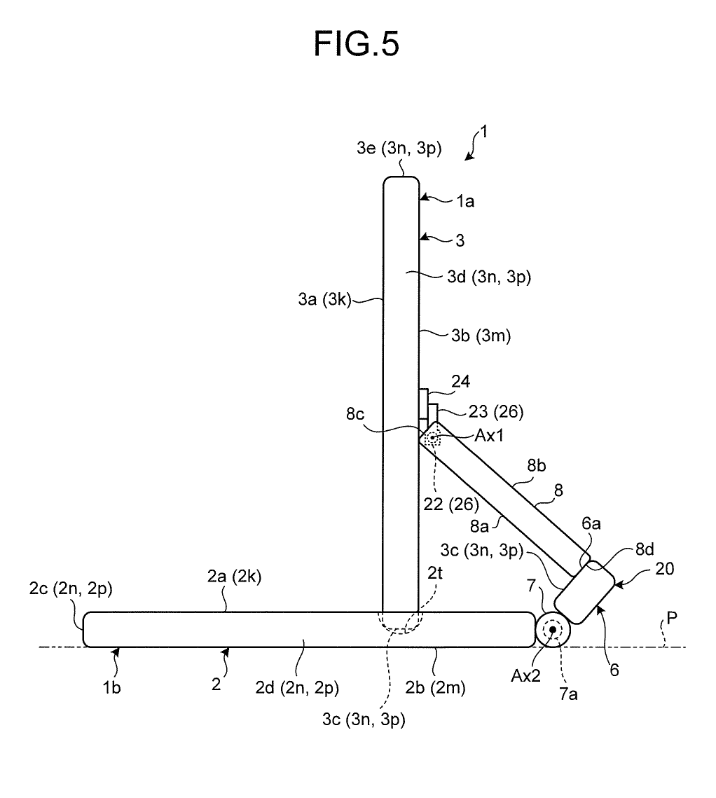

In the embodiment, between the end 2c and the end 2e (an intermediate portion) of the wall 2k, a groove-like recess 2t (recessed groove, housing, catching portion, or engagement portion) extending nearly parallel to the ends 2c and 2e is provided as one example. As will be apparent by referring to FIGS. 4 and 5, the end 3c of the housing 3 is inserted into the recess 2t on which the end 3c is caught in a disengageable manner.

In the embodiment, as illustrated in FIG. 11 as one example, the housing 2 comprises the keyboard module 9 (keyboard, input operation module, or input receiving module) comprising a plurality of keys 9a. In the embodiment, the keyboard module 9 is provided on the wall 2k as one example. The keys 9a are exposed from the wall 2k (the face 2a). The keyboard module 9 is an example of the electrical components 10. The recess 2t is provided between the keyboard module 9 and the end 2e, and the recess 2t is positioned closer to the keyboard module 9 out of the keyboard module 9 and the end 2e. Furthermore, in the embodiment, the recess 2t is provided between a rotational axis Ax2 of the connecting mechanism 20 and the keyboard module 9 as one example.

In the embodiment, as illustrated in FIG. 1 as one example, on the end 2e side (posterior side or side opposite the end 2c) of the housing 2 than a portion in which the keyboard module 9 is provided, further housed (provided) as the electrical components 10 (components or second electrical components) are a circuit board 11 (substrate, printed circuit board, or control board), a battery module 15 (battery, assembled battery, cell, module, battery pack, or battery unit), a speaker module 16 (speaker unit, speaker assembly, speaker, or audio output device), an antenna module 17 (antenna unit, antenna assembly, antenna, or second transmitting and receiving module), and the like. The antenna module 17 provided on the housing 2 (the device 1b) is electrically connected to the circuit board 11 (second electrical components) provided on the housing 2, and transmits and receives data to and from the antenna module 17 (first transmitting and receiving module) provided on the device 1a in a wireless manner. In the embodiment, the keyboard module 9 and the electrical components 10 other than the keyboard module 9 are arranged on the opposite sides across the recess 2t as one example. In the embodiment, the electrical components 10 other than the keyboard module 9 are positioned between the keyboard module 9 and the rotational axis Ax2 of the connecting mechanism 20. Consequently, in accordance with the embodiment, as compared with the case in which the keyboard module 9 and the electrical components 10 other than the keyboard module 9 are housed in the housing 2 in an overlapping manner in the thickness direction, the housing 2 is likely to be thin as one example.

In the embodiment, the antenna module 17 of the device 1b performs communication with the antenna module 17 (see FIG. 9) of the device 1a in a wireless manner to transfer data as one example. The data transmitted from the antenna module 17 of the device 1b to the antenna module 17 of the device 1a is, for example, the data in response to (indicating) the input operation of the keyboard module 9. The data transmitted from the antenna module 17 of the device 1a to the antenna module 17 of the device 1b is, for example, the data to make the speaker module 16 of the device 1b output sound. Consequently, in the embodiment, the electrical components 10 of the device 1b serve as an input module or an output module (corresponding to the controller (not depicted)) of the device 1a as one example.

Next, the connecting mechanism 20 will be described. In the embodiment, as illustrated in FIGS. 1 to 5 as one example, the connecting mechanism 20 comprises a movable portion 8 (link member) provided to the device 1a (the housing 3), and a rotating portion 6 (link member or connecting portion) provided on the device 1b (the housing 2). In the connecting mechanism 20, the angle of the housing 3 with respect to the housing 2 can be changed by the movement of at least one of the movable portion 8 and the rotating portion 6 as one example.

In the embodiment, as illustrated in FIGS. 7, 8, 10, and the like for example, the movable portion 8 appears in a quadrangular shape. Furthermore, the movable portion 8 is configured in a flat rectangular parallelepiped shape for example. The movable portion 8 comprises a face 8a and a face 8b opposite the face 8a. The face 8a and the face 8b are provided in a posture facing opposite to each other (in parallel with each other as one example in the embodiment). The movable portion 8 further comprises an end 8c (first part) and an end 8d (second part) opposite the end 8c.

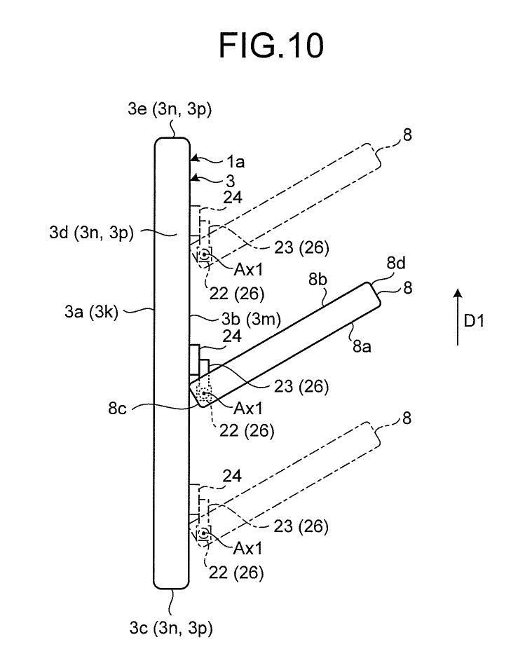

The end 8c of the movable portion 8 is rotatably connected to the housing 3 around a rotational axis Ax1 (first rotational axis, axis, or shaft core) and reciprocatably connected to the housing 3 in a direction intersecting the rotational axis Ax1 (direction of an arrow D1 in FIG. 10 and the opposite direction thereof). In detail, the end 8c is connected to the housing 3 via a shaft member 22, link arms 23 (link members), sliders 24, and rails 25 (guiding portions, see FIG. 7). In the embodiment, the central axis of the shaft member 22 is the rotational axis Ax1.

The shaft member 22 is provided to the movable portion 8. The shaft member 22 is housed (built) in the movable portion 8, for example. The rotational axis Ax1, which is the central axis of the shaft member 22, extends in a direction (the direction of an arrow D2 in FIG. 7) along the display screen 4a and along a direction intersecting (orthogonal for example) the direction from the end 3c of the housing 3 towards the end 3e (the direction of an arrow D1 in FIG. 7). The shaft member 22 is fixed to the movable portion 8, for example. Parts of the shaft member 22 are exposed from two openings 8e (cutout portions, see FIG. 7) provided to the end 8c. The link arms 23 are rotatably supported by the shaft member 22 in a state in which a part of the link arms 23 is positioned in the respective openings 8e. The sliders 24 are provided to the portions of the link arms 23 on the side opposite the shaft member 22. The sliders 24 are fixed to the link arms 23, and are rotatable around the shaft member 22 (the rotational axis Ax1) as the center together with the link arms 23. More specifically, the sliders 24 are rotatably connected to the end 8c around the shaft member 22 (the rotational axis Ax1). The rails 25 are provided to the wall 3m (the face 3b) of the housing 3 extending along the ends 3d and 3f. The rails 25 movably support the sliders 24 to slide in a direction (the direction of the arrow D1 and the direction opposite to the arrow D1) along the direction from the end 3c of the housing 3 towards the end 3e (the direction of the arrow D1). By the foregoing construction, the end 8c is thus rotatably connected to the housing 3 around the rotational axis Ax1 and reciprocatably connected to the housing 3 along the direction from the end 3c towards the end 3e.

The shaft member 22 and the link arms 23 further configure hinges 26. The hinges 26 hold the relative position of the movable portion 8 and the housing 3 by a rotational resistance torque that arises between the shaft member 22 and the link arms 23 as one example. Receiving a torque exceeding the rotational resistance torque changes the relative position of the movable portion 8 and the housing 3. Furthermore, between the rails 25 and the sliders 24, a predetermined binding force acts thereon. The binding force is, for example, a frictional force between the rails 25 and the sliders 24. Receiving a force exceeding the binding force moves the sliders 24 to slide with respect to the rails 25.

A posture of the movable portion 8 thus configured can be changed between a posture at which the movable portion 8 is along the housing 3 (the face 3b) (see FIG. 1) and a posture at which the movable portion 8 is raised with respect to the housing 3 (the face 3b) (see FIG. 4), for example. In the embodiment, the movable portion 8 can be rotated 180 degrees, for example.

The end 8d of the movable portion 8 is rotatably connected, as illustrated in FIGS. 1 to 5, to the housing 2 via the rotating portion 6 around the rotational axis Ax2 (second rotational axis, axis, or shaft core) extending along the rotational axis Ax1, as well as the end 8d is detachably connected to the housing 2 via the rotating portion 6. In the embodiment, as illustrated in FIGS. 1 to 5 and 11 for example, the rotating portion 6 is configured in an elongated columnar (tubular or rod-like) shape extending in parallel with the extending direction of the ends 2c and 2e (longer direction of the housing 2). The rotating portion 6 appears in a rectangular parallelepiped shape, for example. The rotating portion 6 comprises a face 6a to which the end 8d is detachably connected. The face 6a is configured to be planar. Furthermore, in the embodiment, in a state in which the end 8d is connected to the face 6a, the end 3c of the housing 3 and the face 6a face each other (see FIG. 1). In the embodiment, the rotating portion 6 further comprises a permanent magnet as one example, and thus the rotating portion 6 magnetically attracts a magnetic body provided on the movable portion 8 (the end 8d). The magnetic body can be, for example, a wall of the movable portion 8 composed of metallic material, a metallic material provided by insert molding on the wall of the movable portion 8 composed of synthetic resin, and a permanent magnet separately provided on an inner side of the wall (housing) of the movable portion 8. The movable portion 8 may comprise a permanent magnet, and the rotating portion 6 may comprise a magnetic body that is attracted by the permanent magnet. Moreover, on at least one of the movable portion 8 and the rotating portion 6, provided can be a mechanism such as a mechanism (structure, engagement mechanism, catching mechanism, and the like, not illustrated) that mechanically and detachably connects the movable portion 8 and the rotating portion 6, a mechanism (structure, recessed and projecting shapes, recess, or projection, not illustrated) that positions the movable portion 8 and the rotating portion 6, and a mechanism (structure, recessed and projecting shapes, recess, or projection, not illustrated) that guides the attaching and detaching of the movable portion 8 and the rotating portion 6.

In the embodiment, the rotating portion 6 is rotatably connected to the end 2e of the housing 2 via a hinge 7, for example. The rotating portion 6 is rotatable (rotatable about 90 degrees as one example) between the position in which the face 6a is nearly parallel to the face 2a of the housing 2 (see FIG. 1) and the position in which the face 6a is nearly perpendicular with respect to the face 2a of the housing 2 (see FIG. 2), for example. The hinge 7 comprises a shaft member 7a, and is provided on the end 2e of the housing 2. In the embodiment, the central axis of the shaft member 7a is the rotational axis Ax2. The rotational axis Ax2 extends along the rotational axis Ax1. In the embodiment, the rotational axis Ax2 is parallel to the rotational axis Ax1, for example. The rotating portion 6 is rotatable around the rotational axis Ax2 (the shaft member 7a). The hinge 7 holds the posture of the rotating portion 6 with respect to the housing 2 by the rotational resistance torque (frictional resistance) of the shaft member 7a and a sliding member (not depicted) that is slidable on the shaft member 7a. Receiving a torque exceeding the rotational resistance torque changes the posture of the rotating portion 6 with respect to the housing 2. As in the foregoing, the rotating portion 6 is rotatably connected to the housing 2 around the rotational axis Ax2, and the end 8d is detachably connected to the rotating portion 6.

The connecting mechanism 20 thus constructed allows, while the movable portion 8 is positioned along the housing 3 (FIGS. 1 and 2), the housing 3 to be rotationally moved between an expanded position (expanded state, FIG. 1) in which the housing 3 is in a state of being raised with respect to the housing 2 and an overlapping position (overlapping state, FIG. 2) in which the housing 3 and the housing 2 are in a state of overlapping with each other. As in the foregoing, in the embodiment, the housing 3 and the housing 2 can overlap with each other. The connecting mechanism 20 can further hold the posture of the housing 3 with respect to the housing 2 at any position. In the expanded state (FIG. 1), the housing 3 can be reciprocated along a contacting and separating direction with respect to the face 6a of the rotating portion 6 (the direction of an arrow D1 and the opposite direction thereof in FIG. 1). At this time, the housing 3 is held at any position by the binding force of the rails 25 and the sliders 24 as one example. The housing 3 can consequently be held in a state in which the housing 3 is positioned on the upper side than the state depicted in FIG. 1. Furthermore, in the state of the housing 3 and the housing 2 overlapping with each other, the display screen 4a (the display device 4) is covered with the housing 2, and the keys 9a (the keyboard module 9) are covered with the housing 3.

In the embodiment, the housing 3 can be made in a engaged state in which the end 3c is engaged with the recess 2t from the expanded state (FIG. 1), for example. In the engaged state, as illustrated in FIGS. 4 and 5, the angle (posture) of the housing 3 with respect to the housing 2 can be changed by the movement of the connecting mechanism 20. As one example, the housing 3 being supported by the housing 2 in a backward inclining posture (posture inclining further backward towards farther away from the placement surface P) makes the display screen 4a easier to view as compared with the housing 3 being supported by the housing 2 in a posture perpendicular to the placement surface P. In the embodiment, the user can manipulate the housing 3 to change the position (posture) of the housing 3, for example. As in the foregoing, in the embodiment, the housing 3 can assume a plurality of different postures with respect to the housing 2.

Furthermore, in the embodiment, the device 1a (the housing 3) removed from the device 1b (the housing 2) can be used independently (tablet mode). At this time, the device 1a can be used in a state in which the movable portion 8 is placed along the housing 3 or in a state in which the movable portion 8 is raised with respect to the housing. In the state in which the movable portion 8 is placed along the housing 3, the user can easily hold and use the device 1a, for example. In the state in which the movable portion 8 is raised with respect to the housing, the user can use the device 1a in a state in which the end 3c of the housing 3 and the end 8d of the movable portion are placed on the placement face P and the housing 3 is raised and made to incline with respect to the placement surface P.

While the housing 3 comprising the display device 4 is in a raised state (posture) in the embodiment, the housing 3 is moved from the state in which the end 3c of the housing 3 faces the rotating portion 6 to the state in which the end 3c is engaged with the recess 2t. Thus, the display device 4 with the touch panel 5 as an input operation module and the keyboard module 9 as another input operation module can be arranged closer together. Consequently, the user can switch between a state of operating the keyboard module 9 with fingers and a state of operating the touch panel 5 with fingers with relative ease or with relative rapidity as one example.

Furthermore, with the configuration in which the housing 3 is raised from the end 2e of the housing 2 as in a conventional commonly-used clamshell personal computer, when an external force is exerted on the housing 3 towards the back thereof (back side or side opposite to the display screen 4a) such as the user pressing the display screen 4a, the electronic device 1 may fall backward (topple over). Such an incident is likely to occur when the weight of the housing 3 is relatively large such as the housing 3 comprising the battery module 15. In this regard, in the embodiment, as illustrated in FIGS. 4, 5, and the like for example, the movable portion 8 and a portion of the housing between the posterior end of the recess 2t and the end 2e of the housing 2 are positioned behind the end 3c of the movable portion 8 in a state (posture) in which the end 3c of the housing 3 is engaged with the recess 2t of the housing 2. As a consequence, in accordance with the embodiment, the electronic device 1 is hard to fall backward (hard to topple over) even when an external force is exerted on the housing 3 towards the back thereof as one example. The electronic device 1 is thus harder to fall over (harder to topple over) even when the housing 3 receives an external force by input operation performed on the touch panel 5 in a state illustrated in FIG. 4 as one example.

As in the foregoing, in the embodiment, the electronic device 1 comprises the movable portion 8 for example. The movable portion 8 comprises the ends 8c and 8d, and changes the angle of the housing 3 with respect to the housing 2. The end 8c is rotatably connected to the housing 3 around the rotational axis Ax1 as well as the end 8c is reciprocatably connected to the housing 3 in a direction intersecting the rotational axis Ax1. The end 8d is rotatably connected to the housing 2 around the rotational axis Ax2 that extends along the rotational axis Ax1 as well as the end 8d is detachably connected to the housing 2. Consequently, in accordance with the embodiment, the housing 3 can be attached and detached with respect to the housing 2 and the angle (posture) of the housing 3 can be changed with respect to the housing 2, and thus the electronic device 1 is easy to use, for example. More specifically, in accordance with the embodiment, as compared with the case in which the movable portion 8 is not provided, the electronic device 1 with the improved usability is obtainable.

Furthermore, in the embodiment, the housing 2 comprises the recess 2t with which the end 3c of the housing 3 is engaged in a disengageable manner. As a consequence, in accordance with the embodiment, the housings can be supported by the recess 2t and the movable portion 8, and thus the posture of the housing 3 with respect to the housing 2 can be further stabilized.

Moreover, in the embodiment, the recess 2t is provided between the rotational axis Ax2 and the keyboard module 9, for example. Consequently, in accordance with the embodiment, the display device 4 (the housing 3) is likely to be arranged closer to the keyboard module 9 as one example.

In the embodiment, the electronic device 1 comprises the rotating portion 6, for example. The rotating portion 6 is rotatably connected to the housing 2 t around the rotational axis Ax2, and is detachably connected to the end 8d of the movable portion 8. The end 8d of the movable portion 8 is thus detachably connected to the housing 2 via the rotating portion 6. Consequently, in accordance with the embodiment, as compared with the case in which the movable portion 8 comprises a mechanism to rotatably and detachably connect the end 8d of the movable portion 8 and the housing 2 with each other (mechanism corresponding to the rotating portion 6), the configuration of the movable portion (the device 1a) can be simplified.

In the embodiment, the movable portion 8 can change a position between a position at which the movable portion 8 is along the housing 3 and a position at which the movable portion 8 is raised with respect to the housing 3, for example. When the movable portion 8 is at the position at which the movable portion 8 is along the housing 3, the housing 3 and the housing 2 can overlap with each other. Consequently, in accordance with the embodiment, the electronic device 1 is easier to use. Moreover, the housing 3 and the housing 2 overlapping with each other enables the covering of the display screen 4a with the housing 2 as one example.

In the embodiment, the housing 3 comprises the circuit board 11 and the antenna module 17 that is electrically connected to the circuit board 11 and transmits and receives data in a wireless manner, and the housing 2 comprises the circuit board 11 and the antenna module 17 that is electrically connected to the circuit board 11 and transmits and receives data to and from the antenna module 17 provided on the housing 3 in a wireless manner, for example. Consequently, in accordance with the embodiment, the device 1a and the device 1b are able to perform communication in a wireless manner.

In the embodiment, the electronic device 1 comprises the electrical components 10 (the circuit board 11 for example) that are provided between the keyboard module 9 and the rotational axis Ax2 and are electrically connected to the keyboard module 9 as one example. Consequently, the housing 2 is likely to be constructed to be thinner as one example.

Furthermore, the specification (such as the structure, type, direction, shape, size, length, width, thickness, height, number of pieces, arrangement, position, and material) of each constituent element can be implemented with appropriate changes. For example, the movable portion 8 may be detachable with respect to the housing 3 in place of the housing 2, or may be detachable with respect to both the housing 2 and the housing 3. The catching portion is not restricted to the recess 2t, and may be a projecting portion for example.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display device comprising a display screen;
a first housing comprising a first end and a second end opposite the first end, the display device being positioned between the first end and the second end, the first housing being configured to support the display device;
a second housing; and
a movable portion comprising a first part and a second part, wherein
the first part is rotatably connected to the first housing around a first rotational axis and reciprocatably connected to the first housing in a direction intersecting the first rotational axis,
the second part is rotatably connected to the second housing around a second rotational axis extending along the first rotational axis and detachably connected to the second housing, and
the movable portion is configured to change an angle of the first housing with respect to the second housing.

2. The electronic device of claim 1, wherein the second housing comprises an engagement portion configured to be engageably engaged with the first end.

3. The electronic device of claim 2, further comprising an input operation module provided to the second housing, wherein
the engagement portion is provided between the second rotational axis and the input operation module.

4. The electronic device of claim 1, further comprising a rotating portion configured to be rotatably connected to the second housing around the second rotational axis and to which the second part is detachably connected, wherein
the second part is detachable with respect to the second housing via the rotating portion.

5. The electronic device of claim 4, wherein
the rotating portion comprises a surface to which the second part is detachably connected, and
the first end and the surface are capable of opposing each other in a state in which the second part is connected to the surface.

6. The electronic device of claim 1, wherein
the movable portion is capable of changing a position between a first position at which the movable portion is along the first housing and a second position at which the movable portion is raised with respect to the first housing, and
the first housing and the second housing overlap with each other when the movable portion is positioned at the first position.

7. The electronic device of claim 1, further comprising:
a first electrical component provided to the first housing;
a second electrical component provided to the second housing;
a first transmitting and receiving module provided to the first housing, configured to be electrically connected to the first electrical component, and configured to transmit and receive data in a wireless manner; and
a second transmitting and receiving module provided to the second housing, configured to be electrically connected to the second electrical component, and configured to transmit and receive data to and from the first transmitting and receiving module in a wireless manner.

8. The electronic device of claim 3, further comprising an electrical component positioned between the input operation module and the second rotational axis, provided to the second housing, and electrically connected to the input operation module.

9. An electronic device comprising:
a display device comprising a display screen;
a first housing comprising a first end and a second end opposite the first end, the display device being positioned between the first end and the second end, the first housing being configured to support the display device; and
a movable portion comprising a first part and a second part, wherein
the first part is rotatably connected to the first housing around a first rotational axis and reciprocatably connected to the first housing in a direction intersecting the first rotational axis,
the second part is rotatably connected to a second housing around a second rotational axis extending along the first rotational axis and detachably connected to the second housing, and
the movable portion is configured to change an angle of the first housing with respect to the second housing.

10. An electronic device comprising:
a first housing comprising a first end and a second end opposite the first end;
a second housing; and
a movable portion comprising a first part and a second part, wherein
the first part is rotatably connected to the first housing around a first rotational axis and reciprocatably connected to the first housing in a direction intersecting the first rotational axis,
the second part is rotatably connected to the second housing around a second rotational axis extending along the first rotational axis and detachably connected to the second housing, and
the movable portion is configured to change an angle of the first housing with respect to the second housing.
